(19) United States
(12) Patent Application Publication
(10) Pub. No.: US 2012/0175872 A1
(43) Pub. Date: Jul. 12, 2012

(54) PIPE JOINING DEVICE

(76) Inventors: Kevin Albert Lindsey, Nottingham (GB); Laurence Paul Turner, Leicester (GB)

(21) Appl. No.: 13/424,714

(22) Filed: Mar. 20, 2012

Related U.S. Application Data
(63) Continuation of application No. PCT/GB2010/051631, filed on Sep. 30, 2010.

(30) Foreign Application Priority Data
Sep. 30, 2009 (GB) 0917158.8

(51) Int. Cl. F16L 41/08; F16L 1/00; B32B 37/14

(52) U.S. Cl. 285/189; 156/157; 137/15.09

(57) ABSTRACT

A pipe joining device for forming a junction in pressurised and rehabilitated pipes between a first pipe and a branch pipe, the pipe joining device including a substantially rigid body at least in part of thermoplastic, the body including a first pipe sealing portion adapted to form a seal with the first pipe and a branch pipe sealing portion adapted to form a seal with the branch pipe.

### CROSS-REFERENCE TO RELATED APPLICATIONS

The present application is a continuation of pending International patent application PCT/GB2010/051631 filed on Sep. 30, 2010 which designates the United States and claims priority from United Kingdom Patent Application 0917158.8 filed on Sep. 30, 2009, the content of which is incorporated herein by reference.

### FIELD OF THE INVENTION

The present invention relates to a pipe joining device for forming a junction in pressurised pipes between a first pipe and a branch pipe. In particular, it relates to a rehabilitated pipe junction forming device of thermoplastics for joining a branch pipe to the wall of a rehabilitated main pipe having a thermoplastic component in a pressurised water system. It also relates to a method of forming a junction between a branch pipe and a rehabilitated first pipe that is lined with a layer of thermoplastic using a pipe joining device in a system subject to pressure.

### BACKGROUND OF THE INVENTION

The term ‘pipe’ as used herein includes pipes, tubes, ducts and conduits, for conveying fluids, particularly mains pressure water. A branch pipe is a pipe that intersects with another pipe. Branch pipes are also commonly referred to as laterals', although other terms will be familiar to those skilled in the art. Branch pipes are common in water distribution networks where the main, water delivery pipe includes several branch pipes in its wall to deliver a proportion of the water to individual residences, for example.

Pipes used for mains water supplies are often made of cast iron, and failure due to corrosion is becoming an increasing problem as existing systems age. It is generally cheaper and causes less disruption if such pipes are rehabilitated by lining rather than being removed and replaced. Various different techniques for lining existing pipes are known, but there is a demand for more efficient rehabilitation techniques. The invention has particular application in the connection of a ferrule pipe (i.e. a small bore pipe of around 35 mm or less, typically around 20-35 mm, in outside diameter) that leads directly to a household from a rehabilitated mains water pipe.

Each main pipe may have a number of junctions with branch pipes. It is very expensive and time consuming to dig down to underground pipes to make repairs to pipes, particularly between main pipes and branch pipes.

A number of prior art patents refer to rehabilitation of pipes using thermosetting plastic pipe liners and branch pipe liners. For example, U.S. Pat. No. 5,927,341 discloses methods for lining junctions in pipes. U.S. Pat. No. 4,434,115 and WO 2009/105 822 also disclose liners for lateral pipes. WO 0196092 discloses a technique for laying a branch pipe liner. Furthermore, US 2009/183794, U.S. Pat. No. 7,503,349 and U.S. Pat. No. 6,068,725 also disclose branch pipe lining techniques. All of these documents disclose the use of thermosetting materials. These materials comprise a matting material and a resin. The resin has a finite shelf life, particularly at high ambient temperatures. When the resin is applied to the matting, it must diffuse evenly throughout the matting to ensure structural integrity, which is not always reliable.

US Patent Application Number 2006/182 500 discloses a technique of lining underground pipes using thermoplastic. This patent discloses a means of sealing a branch pipe line to a main pipe line by welding a shaped thermoplastic stub to a main pipe lining section, also made of thermoplastic material. A flange is then formed on the end of said stub. The stub is then encased within a metal sleeve. This procedure is a complex, multi-stage process, requiring many nuts and bolts to be tightened around the joint. It also requires access from outside the main pipe line to the start of the branch pipe line, which will usually require expensive excavation work around the pipe line.

### SUMMARY OF THE INVENTION

According to a first aspect of the invention we provide a pipe joining device for forming a junction in pressurised pipes between a first pipe and a branch pipe, the pipe joining device comprising a substantially rigid body of thermoplastic, the body including a first pipe sealing portion adapted to form a seal with the first pipe and a branch pipe sealing portion adapted to form a seal with the branch pipe.

This is advantageous as the pipe joining device can be quickly and easily inserted into a branch pipe and the seals made effective with the main pipe and branch pipe. The pipe joining device thereby effectively either repairs a leaking pipe joint between two separate pipes or makes a connection between two separate pipes by providing a water-tight seal. The formation of a reliable junction in pipes subject to pressure, such as mains water pipes, is difficult but the present invention can form a robust connection. Further, a pipe joining device of thermoplastics can operate reliably over a wide range of ambient temperatures, such as from −30° C. to 60° C. It has also been found that thermoplastics can be re-melted several times without any substantial material degradation.

Preferably, the pipe joining device is adapted to be inserted into the branch pipe from within the main, first pipe.

Preferably, the first pipe sealing portion is adapted to form a seal with the inside wall of the first pipe. Preferably, the first pipe sealing portion is adapted to be welded to the first pipe to form the seal with the first pipe. Accordingly, the pipe joining device may be adapted to be used with first pipes of thermoplastic, thermoplastic composites (such as those that include fibres) or those that include at least an inside wall of thermoplastic; i.e. first pipes having a thermoplastic component. Rehabilitated pipes tend to be lined with a layer of thermoplastic and therefore the present invention is particularly suited for use with such rehabilitated pipes. Further, the thermoplastic of the first pipe and the thermoplastic of the pipe joining device can be easily “melted” by welding, and then joined to form a seal.

Preferably, the branch pipe sealing portion comprises a sealing element mounted to the body. In particular, the branch pipe sealing portion may comprise a groove in the body having the sealing element mounted therein. This is advantageous as a sealing element, such as an O-ring seal or seal of other cross-section, can be mounted in the groove, which is reliable and cost-effective. Alternatively, the sealing element may comprise a silicone bead that is adapted to expand on contact with water to establish a seal between the pipe joining device and the branch pipe. This is particularly advantageous as the pipe joining device was developed for use connecting a mains water pipe (the first pipe) to a ferrule pipe (the branch pipe) which delivers potable water under pressure to a household. The typical diameter of a ferrule pipe is around 35 mm and therefore the O-rings or silicone bead provide a simple and easy method of obtaining a reliable seal with such a relatively small bore pipe.

Preferably, the branch pipe sealing portion is adapted to form a seal with the branch pipe as it is pushed into the branch pipe. This is advantageous as the pipe joining device is easy to install and does not require substantial expansion into contact with the pipe as it is a substantially rigid, easy to install member. Further, pipe joining devices that comprise flexible sections that are required to be expanded and set do not have the strength to reliably operate under pressure, such as in a mains pressure water supply system.

Preferably, the body comprises a tubular portion having a substantially radially outwardly extending flange portion, the tubular portion including the branch pipe sealing portion and the flange portion including the first pipe sealing portion.

Preferably the tubular portion has a wall thickness of substantially 10% to 50%, and most preferably 20-35% of the outside diameter of the tubular portion. This ensures that it can cope with the pressure of a mains water system. Preferably, the diameter of the flange portion is substantially twice the outside diameter of the tubular portion. It has been found that these dimensions allow a reliable junction to be formed. Preferably, the thickness of the flange portion is approximately 10-15% of the outside diameter of the flange.

Preferably, the flange portion tapers in thickness as it extends outwardly from the tubular portion. This is advantageous as it improves the quality of a weld between the first pipe sealing portion and the first pipe as the taper ensures a close contact between the first pipe and the first pipe sealing portion.

Preferably the flange portion comprises a ring shaped member having a surface that is cylindrically curved such that is complimentary to a cylindrically curved inside surface of the first pipe. This is advantageous as it improves the quality of a weld between the first pipe sealing portion and the first pipe.

Preferably the first pipe sealing portion is annular and approximately 5 mm wide.

According to a second aspect of the invention we provide a method of forming a junction between a branch pipe and a rehabilitated first pipe that is lined with a layer of thermoplastic using a pipe joining device in a system subject to pressure, the pipe joining device comprising a body of thermoplastic, the body including a first pipe sealing portion and a branch pipe sealing portion, the method comprising the steps of;
a) inserting the branch pipe sealing portion into the branch pipe from the main pipe;
b) establishing a seal between the branch pipe sealing portion and the branch pipe;
c) abutting the first pipe sealing portion against the layer of thermoplastics of the first pipe;
d) establishing a seal between the first pipe sealing portion and the first pipe.

The method is advantageous as it provides an easy to install and reliable junction.

Preferably step d is achieved by welding the first pipe sealing portion to the layer of thermoplastics that lines the inside wall of the first pipe.

Preferably step b is achieved by a sealing element mounted to the branch pipe sealing portion. Preferably the sealing element is arranged such that step b comprises establishing a seal when the branch pipe sealing portion is inserted into the branch pipe by interference between the pipe sealing portion and an inner wall of the branch pipe.

Preferably the method includes the step of determining the size of the branch pipe and selecting a pipe joining device that is dimensioned to form a seal with the branch pipe as it is inserted into the branch pipe. Thus, the pipe joining device will be preformed complimentary to the first pipe and branch pipe.

Preferably the method includes the step of cutting a hole through the layer of thermoplastics to provide access to the branch pipe.

The method may include the step of pressurising the system containing the junction formed by the pipe joining device, possibly with water. This may include pressurising the system with mains potable water supply pressure, which may comprise pressures around 1 to 5 bar (100 to 500 kPa) and potentially up to 30 bar (3000 kPa).

### BRIEF DESCRIPTION OF THE DRAWINGS

There now follows by way of example only a detailed description of the present invention with reference to the accompanying drawings in which

FIG. 1 shows a first pipe having two branch pipes intersecting therewith;

FIG. 2 shows a transverse cross-section of a joint between a main pipe and a branch pipe of FIG. 1;

FIG. 3 shows an isometric view of a first embodiment of the pipe joining device;

FIG. 4 shows a cross section of the pipe joining device of FIG. 3 mounted within a junction between a main pipe and a branch pipe; and

FIG. 5 shows a further embodiment of the pipe joining device.

### DETAILED DESCRIPTION OF THE INVENTION

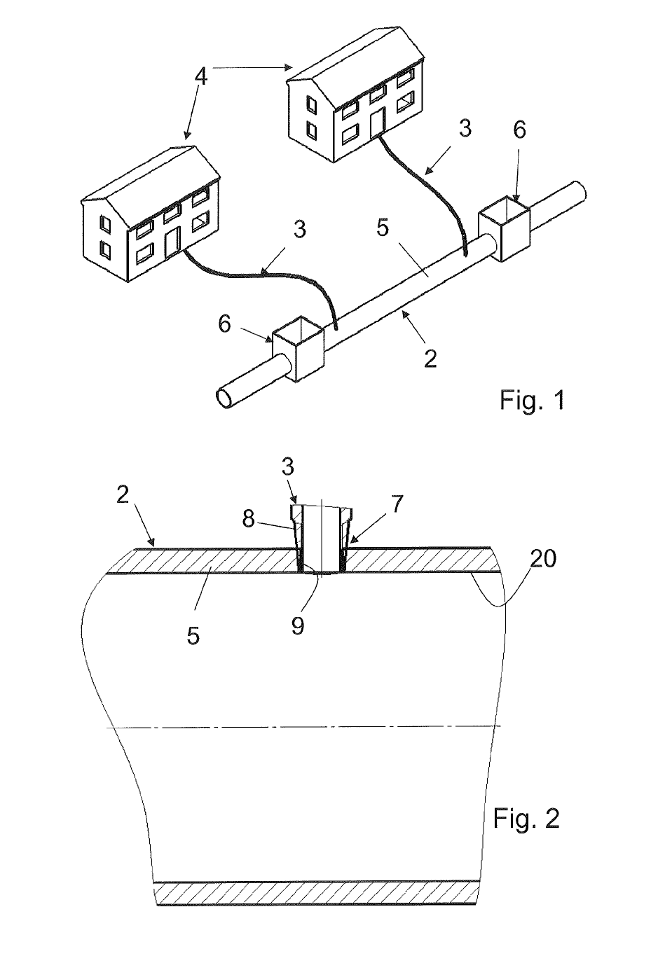

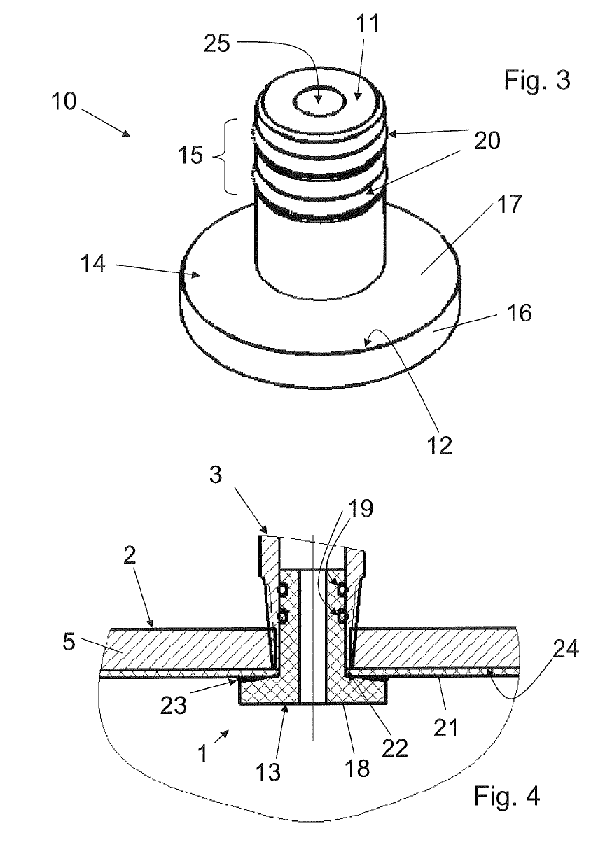

A first embodiment of the pipe joining device 1 is shown in FIG. 3 and is adapted for use at the junction of a first pipe 2 with a ferrule (branch) pipe 3 in a mains water supply system. The pipe joining device 1 is adapted to form a junction between a rehabilitated first pipe that includes a layer of thermoplastic on its internal surface and the branch pipe. FIG. 1 shows a part of a common water supply system that extends underground. The ground has not been shown for clarity. The system comprises the main or first pipe 2 and includes the two branch pipes 3, which deliver the water from the first pipe 2 to the residences 4. The branch pipes 3 intersect the first pipe 2 and extend through the wall 5 of the first pipe 2 so as to be in communication with the water present therein. The water supply system also includes two inspection chambers 6. The water supply system is pressurised and therefore the pipe work and pipe joining device will need to be capable of withstanding pressures in the region of 1 to 5 bar (100 to 500 kPa) and potentially up to 30 bar (3000 kPa).

FIG. 2 shows a typical joint between the main pipe 2 and the branch pipe 3 when the water supply system was first built. The main pipe 2 and branch pipe 3 are connected by a threaded joint 7. Thus, a thread would be formed on an outside surface 8 of the branch pipe 3 and a complimentary thread formed in the aperture 9 in the first pipe's wall 5. The branch pipe 3 can then be screwed into the wall 5 of the first pipe 2. This joint can deteriorate over time and a leak may occur.

FIGS. 3 and 4 show a first embodiment of the pipe joining device 1. The pipe joining device 1 comprises a body 10 of thermoplastic having a tubular portion 11 and a flange portion 12. The flange portion 12 extends radially outwardly from one end 13 of the tubular portion 11. The flange portion 12 includes a first pipe sealing portion 14. The tubular portion 11 includes a branch pipe sealing portion 15. The tubular portion has a bore 25 extending therethrough.

The flange portion 12 has an outside edge 16, a first surface 17 and a second surface 18. The first surface 17 is adapted to contact the first pipe 2 and therefore includes the first pipe sealing portion 14. The first surface tapers and forms a conical ring. Thus, the flange portion tapers and reduces in thickness towards the outside edge 16.

The branch pipe sealing portion 15 comprises a sealing element 20 mounted to the tubular portion 11. In this embodiment the sealing element 20 comprises two O-ring seals 20 of elastomeric material. Each sealing elements 20 is mounted in a respective groove 19. The grooves 19 extend radially into the tubular portion 11. It will be appreciated that one sealing element 20 may be sufficient depending on the pressures that will be experienced by the pipe joining device 1. If one sealing element 20 is used only one groove is necessary. Also, sealing elements 20 of other cross-sections may be used such as square cross-section.

FIG. 4 shows the first pipe 2 of FIG. 2 after it has been rehabilitated by lining. Accordingly, the pipe 2, which is of cast iron, has its inside surface 24 covered by a liner 21 of thermoplastic. Thus, the first pipe 2 comprises the wall 5 and the liner 21. Any cracks or holes in the wall 5 of the first pipe 2 are sealed by the liner 21 and the water flows within the liner 21. It will be known to those skilled in the art how a pipe can be lined and therefore this process will not be described in more detail herein.

A port 22 has been cut in the liner 21 to provide access to the branch pipe 3 from the first pipe 2. The pipe joining device 1 has been mounted through the port 22, and into the junction of the first pipe 2 with the branch pipe 3. The tubular portion 11 extends inside the branch pipe 3 and the branch sealing portion 15 contacts the inside surface of the branch pipe 3. The O-ring sealing elements 20 contact the branch tube 3 and form a seal between the pipe joining device 1 and the branch pipe 3. The flange portion 12 remains within the first pipe 2 and the first pipe sealing portion 14 abuts the inside surface 24 of the first pipe 2, i.e. the liner 21 in this embodiment. It will be appreciated that due to the taper of the flange portion 12, it will make close contact with the first pipe 2 as the taper matches the curvature of the pipe 2. However, at positions where the first pipe 2 remains straight (i.e. in the axial direction with respect to the first pipe) the portion proximal the tubular portion 11 will contact the inside of the first pipe 2 initially leaving a gap 23 between a portion of the first surface 17 and the liner 21, in the region opposite the surface 17.

The first pipe sealing portion 14 is adapted to be welded to the liner 21 to form a seal between the pipe joining device 1 and the first pipe 2. In this embodiment the weld is formed by induction welding. However it will be appreciated that friction welding, hot plate welding or other welding techniques may be used. Once welded, the gap 23 is filled with thermoplastic which has melted and reformed to fill the gap. The molten thermoplastic of the first pipe sealing portion 14 joins and seals to the thermoplastic of the liner 21, thereby forming a water-tight seal.

The first pipe sealing portion 14 of the flange portion 12 offers a large surface area to contact the pipe 2 during welding. The conical profile of the first surface 17 is complimentary to the curvature of the liner 21. The flange portion 12 may also incorporate metal wires to promote heating of said flange when induction welding.

Once installed, water from the first pipe 2 can flow into the branch pipe 3 through the bore 25 when the system is re-pressurised. The pipe joining device 1 prevents leakage as it seals against the liner that forms the inside wall of the first pipe 2 and the inside wall of the branch pipe 3 either side of the original joint. This provides a water tight seal at the joint.

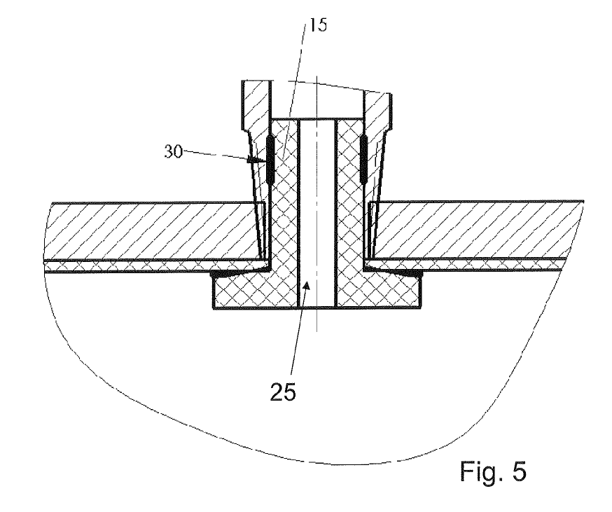

FIG. 5 shows a second embodiment of the pipe joining device 1. Like reference numerals have been used for like parts. In this embodiment, the two O-ring sealing elements 20 and grooves 19 have been replaced with a bead of silicone material 30 that is laid around the outside of the tubular portion 12. This material expands on contact with water to form a seal between the tubular portion 11 of the pipe joining device 1 and the branch pipe 3. Such contact with water occurs when the pipes 2, 3 are refilled once repairs are complete.

It will be appreciated that further modifications to the pipe joining device 1 could be made. In particular, the thermoplastic materials may be reinforced with fibres of various materials. The branch pipe 3 may be of thermoplastic material or may be lined. Indeed, where a new thermoplastic first pipe has been laid, this pipe joining device and method allows a quick and simple method of attaching branch pipe lines to the first pipe line. The sealing element 20 may be such that it is mounted to the tubular portion 11 without the groove or grooves 19.

What is claimed is:

1. A pipe joining device for forming a junction in pressurised pipes between a first pipe and a branch pipe, the pipe joining device comprising a substantially rigid body at least in part of thermoplastic, the body including a first pipe sealing portion adapted to form a seal with the first pipe and a branch pipe sealing portion adapted to form a seal with the branch pipe.

2. A pipe joining device according to claim 1, in which the pipe joining device is adapted to be inserted into the branch pipe from within the main, first pipe.

3. A pipe joining device according to claim 1, in which the first pipe sealing portion is adapted to form a seal with a thermoplastics liner that lines the inside wall of the first pipe.

4. A pipe joining device according to claim 1, in which the first pipe sealing portion is adapted to be welded to the main, first pipe to form the seal with the first pipe.

5. A pipe joining device according to claim 1, in which the pipe joining device is adapted to be used with first pipes having a thermoplastic component.

6. A pipe joining device according to claim 1, in which the branch pipe sealing portion comprises a sealing element mounted to the body.

7. A pipe joining device according to claim 6, in which the branch pipe sealing portion comprises a groove in the body having the sealing element mounted therein.

8. A pipe joining device according to claim 1, in which the sealing element comprises a silicone bead that is adapted to expand on contact with water to establish a seal between the pipe joining device and the branch pipe.

9. A pipe joining device according to claim 1, in which the branch pipe sealing portion is adapted to form a seal with the branch pipe as it is pushed in to the branch pipe.

10. A pipe joining device according to claim 1, in which the body comprises a tubular portion having a substantially radially outwardly extending flange portion, the tubular portion including the branch pipe sealing portion and the flange portion including the first pipe sealing portion.

11. A pipe joining device according to claim 10, in which the flange portion tapers in thickness as it extends outwardly from the tubular portion.

12. A pipe joining device according to claim 10, in which the flange portion comprises a ring shaped member having a surface that is cylindrically curved such that is complimentary to a cylindrically curved inside surface of the first pipe.

13. A pipe joining device according to claim 1, in which the first pipe sealing portion is annular and approximately 5 mm wide.

14. A method of forming a junction between a branch pipe and a rehabilitated first pipe that is lined with a layer of thermoplastics using a pipe joining device in a system subject to pressure, the pipe joining device comprising a body at least in part of thermoplastic, the body including a first pipe sealing portion and a branch pipe sealing portion, the method comprising the steps of;
a) inserting the branch pipe sealing portion into the branch pipe from the main pipe;
b) establishing a seal between the branch pipe sealing portion and the branch pipe;
c) abutting the first pipe sealing portion against the layer of thermoplastics of the first pipe;
d) establishing a seal between the first pipe sealing portion and the first pipe.

15. A method according to claim 14, in which step d is achieved by welding the first pipe sealing portion to the layer of thermoplastics that lines the inside wall of the first pipe.

16. A method according to claim 14, in which step b is achieved by a sealing element mounted to the branch pipe sealing portion.

17. A method according to claim 16, in which the sealing element is arranged such that step b comprises establishing a seal when the branch pipe sealing portion is inserted into the branch pipe by interference between the pipe sealing portion and an inner wall of the branch pipe.

18. A method according to claim 14, in which the method includes the step of determining the size of the branch pipe and selecting a pipe joining device that is dimensioned to form a seal with the branch pipe as it is inserted into the branch pipe.

19. A method according to claim 14, in which the method includes the step of cutting a hole through the layer of thermoplastics to provide access to the branch pipe.

20. A method according to claim 14, in which the method includes the step of pressurising the system containing the junction formed by the pipe joining device.
